(19) United States
(12) Patent Application Publication
(10) Pub. No.: US 2003/0201208 A1
(43) Pub. Date: Oct. 30, 2003

(54) Dynamic superparamagnetic markers

(76) Inventors: Martin Koch, Kobenhavn (DK); Bernhard Wolf, Stegen (DE); Ernst Stetter, Seeheim (DE)

Correspondence Address: ADAM EVANS, P.A., (formerly Adams, Schwartz & Evans, P.A.), 2180 TWO WACHOVIA CENTER, CHARLOTTE, NC, 28282, US

(21) Appl. No.: 10/257,849

(22) PCT Filed: Apr. 24, 2001
(86) PCT No.: PCT/EP01/04613

(51) Int. Cl. B03C 1/30

(52) U.S. Cl. 209/39; 209/215

(57) ABSTRACT

The invention relates to the use of dynamic magnetic fields (DM fields) or DM-field generators for identifying and/or sorting cells, cell components or pathogens, the use of said fields or field generators in the purification of liquids from pathogens, methods or processes for the treatment of infected cells or tumor cells, the use of super-paramagnetically labelled active substances for the preparation of a composition for use in a process for the treatment of infected cells or tumor cells, comprising treatment with a DM field or DM field generator, as well as the combination of super-paramagnetically labelled active substances or superparamagnetically labelled beads with a generator of a DM field. FIG. 3 shows, as example, a microscope (12) under which a super-paramagnetically labelled sample (15) is exposed to a DM alternating field by a field generator (11) and thus the moved labelled objects (e.g. cells) are put into movement and thus become specifically identifiable.

The invention relates to the use of dynamic magnetic fields (DM fields) or DM-field generators for identifying and/or sorting cells, cell components or pathogens, the use of said fields or field generators in the purification of liquids from pathogens, methods or processes for the treatment of infected cells or tumor cells, the use of super-paramagnetically labelled active substances for the preparation of a composition for use in a process for the treatment of infected cells or tumor cells, comprising treatment with a DM field or DM field generator, as well as the combination of super-paramagnetically labelled active substances or super-paramagnetically labelled beads with a generator of a DM field.

### BACKGROUND OF THE INVENTION

Systems for isolating cells marked with superparamagnetic beads or other paramagnetic markers are well known. These are either using cell sorters (see e.g. U.S. Pat. No. 5,837,200), which have a relatively low throughput, or are based on the supply of static magnetic DC fields in order to retain superparamagnetic marked cells via a magnet which produces a nonhomogeneous magnetic DC field and is surrounding a column where only and first after the wash out of the non marked cells by the removal of the magnet it is possible to wash out also the labelled cells (MACS=Magnetically Activated Cell Sorter, ccommercially available from Miltenyi Biotec).

It has also become known that the fields are applied for suppressing of the chain formation of hem molecules in the erythrocytes infected with the infectious agent of malaria, a protozoon called Plasmodium. One form of the infectious agent is normally present in the erythrocytes and, by taking up the protein complex from hemoglobin, has the effect that hem is set free which is then aggregated in long chains. By applying AC fields, chain production was inhibited or chains already formed could be destroyed. Hereby a 33% to 70% decrease of the number of parasites could be achieved. The weakly oscillating magnetic fields which were applied in these experiments from Washington University are low frequent magnetic fields. They should help to withdraw the basis of life of the infectious agents of malaria by destroying hem structures produced in the erythrocytes. The divalent iron ion is magnetic only if it is in the deoxygenated state, so that in this case only deoxygenated blood is of interest.

Already known is also a procedure of a Danish firm (MEDICO-CHEMICAL LAB, APS) where a magnetical medicament is injected directly into the blood stream and is arrested by a strong magnetic field and also enriched at the location where the treatment should be started, e.g. in the area of a tumour. The problem here was to produce a magnetic field strong enough to keep the therapeutic compound in the desired location.

Finally it is also known in the art to administrate iron oxide-containing nanoparticles into a tumor (e.g. by injection) and then bring them locally into vibration by using oscillating fields in such a way that at the site of the nanoparticles temperatures up to 47° C. are reached.

As a consequence the degenerated tissue disintegrates. Breast tumors implanted into mice thus vanished within half an hour. This method, developed at the Humboldt University, uses high frequency fields (kHz, MHz). The electromagnetic fields being effective here, however, are dependent on the material constant and possibly inhomogenous. Their effect, in contrast to that of the dynamic alternating fields that can be described by the first Maxwell equation, can be described by the second Maxwell equation (induction law).

□H·ds=∫(J+∂D/∂t)·dA Maxwell equation 1

□E·ds=−∫(∂B/∂t)·dA Maxwell equation 2

A=area

H=magnetic field

E=electric field

J=current density

s=length

B=magnetic flux density

t=time

∂D/∂t=displacement current density

All of the systems mentioned either apply static magnetic DC fields or simple oscillating AC fields.

Especially in the MACS technique mentioned above, magnetic fields are applied which are produced by a permanent magnet. These inhomogenous, static magnetic DC fields are independent of material constants (J. C. Maxwell, On Faraday's Lines of Force, Scientific Papers 1855, 1856, reprinted Dower, N.Y. 1952), and they are therefore able to penetrate liquids and reach magnetic particles present in the liquid and have effect on them. After installation, however, the magnetic system is statically fixed in the system. There is no doubt that a large number of magnetically labelled (marked) objects (for example cells) in solution are attracted by a strong permanent magnet, though with differing strength.

The patent application WO 95/19217 (corresponding to EP 0 749 578) describes a device which allows to produce really moving electromagnetic fields. In the mentioned patent application this is applied to move ions in a masonry in order to remove salts out of the masonry.

For the therapy of proliferative diseases, such as tumour diseases or cancer, up to now chemotherapy, radiotherapy, surgical treatment, cryotherapy (freezing), hyperthermy (locally or in the whole body abnormally elevated temperature) and immunotherapy, or combinations thereof, are used, for the treatment of infections, for example, antibiotics or other chemotherapeutics, e.g. antiparasitic or antiviral active substances. There is a need to have novel devices and processes for the therapy and diagnosis of this type of diseases at the disposal.

In the beginning of 2000, it was reported in the magazine “Deutsche Ärzte Zeitung” that cancer cultures in laboratory bottles can be influenced in their growth by exposing them to radio speaker noise. This simple experiment shows that cells in culture (here cells of a lung cancer) affected by a mechanical stress grew slower than cells within an unexposed control group. It would be interesting to produce these mechanical effects in other ways.

### SUMMARY OF THE ADVANTAGES OF THE INVENTION

The dynamic marking (labelling) technique according to the invention allows in contrast to the state of the art to work with moving magnetic fields (dynamic magnetic fields, called DM-fields subsequently). These can be combined such that dynamic effects in standing (without Hall-Effect) or moved liquids of low to higher (e.g. gel like) viscosity can be produced. The frequency of these magnetic fields can be chosen such that they can be regarded as material constant independent (the frequency dependent part of the first Maxwell equation can be neglected, the first part of the summand is entirely independent of the material constant). This means that fields of this type can penetrate the respective liquids practically without loss in order to then dynamically affect all magnetically labelled objects, e.g. labelled with magnetic beads, like cells or e.g. liposomes or superparamagnetic labelled active agents (e.g. by rotating, transportation or building up of structure barriers (which are reversibly vanishing after elimination of the fields). Due to this dynamic characteristic of the fields used for the dynamic labelling (DM-fields) electrical forces can be produced in liquids which can influence magnetic and unmagnetic ions (see below FIG. 1).

The weekly oscillating fields used in the experiments of the University of Washington against Malaria mentioned above can also be produced by one of the DM field generators used in the present invention, if the otherwise longitudinally stretched DM field generator is constructed in a round shape comparable to an alternating current (AC) motor, which could then be applied as a kind of cuff around an arm or leg or the whole body. Preferably, however, DM field generators are used that have no ring shape.

It is also possible to cause a mechanical stress for infected tissue or tumor tissue by the DM fields, for example by applying super-paramagnetic beads near a tumor or an infected organ (e.g. liver, brain) (for example by injection at the tumor site or by transport with a DM field itself, or especially by administration of antibodies directed against the tumor or infected cells which antibodies are labelled super-paramagnetically, so that, due to their binding to the tumor cells for example after injection or infusion, they are enriched at the tumor cells), and then magnetically “shaking” or rotating with DM fields. The DM field-generator can here be adapted to the respective requirements with respect to its form, output and frequency.

If ferrite materials are applied instead of racked metal sheets isolated against each other or massive components (appropriate below 15 Hz) as part of a magnetic field generator unit, also higher frequencies (e.g. in the KHz area) can be produced by a DM device.

The hyperthermia effects already described due to iron oxide particles injected into the tumour and externally produced AC fields have destroyed tumours in mice according to reports of Berlin researchers of the Charité/Humbold University. Electromagnetic AC fields which should heat away magnetically labelled tumours over long distances (body of the human) are problematic in view of the long distances with varying material constants (tissue,water etc.). An additional problem is probably also here the magnetisation of the tumour. A simple injection of superparamagnetic beads does not always guarantee a homogeneous optimal distribution. This however can be obtained with the new DM technique in combination with beads to which antibodies against tumour cells or infected cells are conjugated, and if required administering dynamic pressure via the blood supplied parts of the infected tissue.

The field of applications for DM fields is therefore remarkably diverse.

### DETAILED DESCRIPTION OF THE INVENTION

The invention relates to the use of dynamic magnetic fields (DM fields), generatable by multiphase systems supplied with alternating current, or of DM-field generators for identifying and/or sorting cells, cell components or pathogens, especially of such cells, cell components or pathogens that to which super-paramagnetic beads are bound.

The invention also relates to the use of DM fields or DM field generators in the purification of liquids from pathogens, especially those to which super-paramagnetic beads are bound.

The invention also relates to methods or processes for the diagnosis (identification of diseased, for example infected or tumor cells) and especially for the treatment of infected cells or tumor cells comprising the use of DM fields or DM field generators and in particular in addition super-paramagnetic beads which are bound to or are present at the site of infected cells or tumor cells (especially after correspondingly localized administration, e.g. by injection, or, especially if the super-paramagnetic beads are bound to antibodies specific for the mentioned cells (directly, via a spacer or via liposomes), systemic administration).

The invention also relates to the use of super-paramagnetically labelled active substances for the preparation of a composition for use in a process for the treatment of infected cells of tumor cells, comprising treatment with a DM field or a DM field generator, as well as the use of superparamagnetic beads which are (a) administered (for example injected) at the site of the cells, (b) directed there by a DM field or a DM field generator (especially via body cavities)and/or (c) have been or are bound specifically to the mentioned cells, for example via antibodies that are specific for antigens on the cells to be treated and that are bound to the beads (especially bound to the beads directly or via spacers or liposomes) and which beads optionally carry an active substance effective against infection or tumors (bound covalently directly or via a spacer to the beads or within liposomen that are bound to the beads); as well as the combination of superparamagnetically labelled active substances or superparamagneticical beads with a generator of a DM field (DM field-generator).

The expressions used hereinbefore and hereinafter preferably, within the scope of the present disclosure, have the following meanings, if nothing else is indicated—single or several of the corresponding specific definitions may be used instead of the more general definitions used above and then relate to preferred embodiments of the invention:

DM fields (dynamic magnetic fields) are those which can be produced by the DM field generators (producers) described below in more detail. These are wandering (or pulsating, i.e. intermittent) magnetic fields which are produced out of two or more AC fields that are displaced timely and locally.

Application of DM fields or DM field generators and superparamagnetic beads especially means that DM fields or DM field generators are used in order to bring the superparamagnetic beads, especially those which are bound to parts of the cell and/or pathogens, e.g. into longitudinal motion or into rotation, or (by producing static AC fields via a DM field generator) to form structures from them like barriers or rod like structures.

DM fields (dynamic magnetic fields) are characterized in that they obey the first Maxwell equation and therefore relate to magnetic aspects which show material constant independent penetration if sufficiently low frequencies are chosen, as the second part of the sum in Maxwell's first equation is negligible (with other words if only hardly measurable additional heating (heating due to eddy currents) is generated and material constant independent penetration is shown) (in difference hereto the fields used in the Charité rely on the second Maxwell equation which is based on the principle of induction).

DM field generators are described in WO 95/19217, they can be fitted in size and shape to the needs (e.g. by dimensioning them either that they fit onto a microscope table or such that coil system extending over a whole body are formed. In principle they equal linear motors. For the production of the DM fields of this invention AC current supplied multiphase systems are used, meaning systems with two or more coils displaced relatively to each other locally and powered in timely displaced manner, for example in combination with a frequency converter. The multiphase system is preferably placed into a magnetic material in order to achieve concentration and amplification. The windings can for example be placed into a slotted ferromagnetic, laminated core where the laminations (for example by isolating lacquers such as Schellack, coatings or paper) are isolated from each other. In another embodiment of the invention, resistors or coils are connected in between the power supply and the multiphase system which makes it possible to vary the DM AC amplitude. Specific embodiments for this type of device can be found in WO 95/19217 which are incorporated herewith by reference. In another embodiment the DM field generators are fixed such that the DM field is produced solely by the AC fields; preferably they can also be displaced during the DM field production. For the production of the magnetic moving fields, thus the AC supply of the multiphase system is responsible exclusively or at least mainly, however, by moving the DM field generator, the location of the DM field can also be varied. Thus the DM fields differ strongly from permanent magnets producing their fields due to relative motion or from one phase electromagnets (DC or AC powered).

Identifying of cells, cell components or pathogens means that these, after labelling with super-paramagnetic beads, are brought to rotation or moved in a directed way and can thus be observed and recognized (identified) in the presence of unlabelled cells, preferably microscopically. This means that also a method for the diagnosis (e.g. identification of diseased cells from tissue cells or blood) is an embodiment of the present invention.

Sorting of cells, cell components or pathogens means that the corresponding super-paramagnetically labelled cells, cell components or pathogens in solutions can be sorted out of mixtures with unlabelled specimens or can be enriched from them by applying, for example, dynamic magnetic fields or by generating structures (FIG. 4, (18)), for example from flowing solutions by directing them to one side and branching them off only there, or from stagnant solutions, especially units of conserved blood or of blood plasma or nutrient media, for example for organ transplantation or cell cultures, which have to be free from pathogens, as before by concentrating them at one place, for example one side, and then (for example by suction) removing them there. The advantage is that for example nutrient media for cell culturing or conserve units obtained from blood can be purified this way. By sequential use of distinct antibodies thus also several components can be obtained from one sample.

Cell components are, for example, organelles, such as lysosomes, endoplasmic reticulum, vesicles of the cell membrane (e.g. microsomes, canalicular membrane vesicles from bile canaliculi) and the like. Pathogens are also cancer cells, e.g. (for example such that are appropriate for metastasis formation) tumor cells or leukaemia cells or abnormally proliferating cells from bone marrow).

Pathogens are, for example, bacteria including mycoplasms, virus (e.g. HIV, hepatitis virus, such as HCV), fungi (such as yeasts) or parasites (such as protozoa, e.g. trypanosomes or plasmodia, helminths or the like).

Superparamagnetic labelling preferably can be achieved by superparamagnetically labelled antibodies or by superparamagnetically labelled liposomes that further have antibodies bound to them which are specific for the respective cells or pathogens, that is, antigens specifically or to a larger extent expressed there, and bind them. These antibodies are, for example, directed against tumor antigens (e.g. those expressed on the cell surface), peptides presented on the cell surface (for example by antigen presenting proteins such as the Major Histocompatibility Complex or the like) (for example out of pathogens, such as virus or mycoplasms) or against antigens directly present on the pathogens themselves, and are obtainable by standard procedures.

The sorting of cells, cell components or pathogens can also be achieved by means of correspondingly super-paramagnetically labelled antibodies or liposomes, whereby also from flowing or stagnant liquids the labelled components can be enriched at defined locations and then can be branched off or withdrawn. The purification of liquids with cells, cell components or pathogens can be achieved as well in an analogous way.

The treatment of infected cells or tumor cells can take place, for example, extracorporally (e.g. in cell or tissue cultures, for example for the cultivation of hepatic cells from a virus-infected liver, or from isolated bone marrow or a tumor patient in order to remove infected or tumor cells, respectively, and thus to allow for re-implantation). In this way (by sorting out labelled infected or tumoral cells, by their mechanic destruction, by forceful movement and/or by administration of super-paramagnetical, antibody-bound beads that are loaded with active substances, the active substances of which, due to the higher mechanical stress of the bound cells and the selective concentration at the cells, are active there more intensively) the undesired cells are removed and thus purely “healthy” cell- or tissue cultures or cells or tissue parts are obtained that, for example, can be used for heterologous ore preferably autologous transplantation.

However, the treatment may also take place inside the body, preferably in a warm-blooded animal, such as a human, especially if said warm-blooded animal is in need of such treatment. Thus antibody- and super-paramagnetically-labelled beads, preferably loaded with one or more active substances, can be administered to a warm-blooded animal and, after docking to a diseased tissue, be made moving which, on the one hand, mechanically stresses the diseased cells, on the other hand exposes them more strongly to the active substance (for example, because said active substance, due to the DM field, gets into the cell interior).

Also unlabelled beads can be used (especially in body cavities, such as lung, gastro-intestinal tract, abdominal cavity, pleural cavity, brain caverns, spinal medullary canal, hollow spaces in the area of muscle fasciae, etc.). These can first, by means of DM-fields, be directed to the desired position (e.g. tumor, infected organ, e.g. liver) and then, at the face, brought to movement, and thus, due to mechanical stress, can make the diseased areas accessible to the defense response of the body.

The invention also relates to the use of super-paramagnetically labelled active substances for the preparation of a composition for use in a process of treatment of infected cells or tumor cells, comprising the treatment with a DM field, as well as the combination of super-paramagnetically labelled active substances or super-paramagnetic beads with a generator of a DM field, especially one as described in WO 95/19217.

Super-paramagnetic beads are known, can be obtained according to methods that are known in the art, or they are commercially available. The expression “beads” is not intended to compulsorily mean spherical form, but is to be understood in the sense of “small particle”.

For example, the International Patent Application WO 85/02772 describes small particles that are based on a carbon hydrate, poly-amino acid or plastic matrix. Examples for respective carbon hydrate matrices are found in PCT/SE82/00381, PCT/SE83/00106 and PCT/SE83/00268, for corresponding poly-amino acid matrices in U.S. Pat. No. 4,247,406; plastic matrices, for esample based on polymers made from acrylates, polystyrene etc., are also known. Inside the matrix iron oxide particles are embedded, for example. The patent U.S. Pat. No. 4,219,411 describes polystyrene based matrices and especially matrices based on polymerisates of acrylic acid and its derivatives (such as acrylamide, methacrylamide, acrylic acid, methacrylic acid, dimethylaminomethacrylate, hydroxy-loweralkyl- or amino-lower-alkylacrylates, such as 2-hydroxyethyl-, 3-hydroxypropyl- or 2-aminoethyl-methacrylic acid) with free hydroxyl groups that can be activated with cyanogen bromide, or with free carboxyl groups, or with free amino groups, all of which allow the covalent binding to molecules, such as antibodies, avidin or streptavidin. Further patents which describe appropriate particle matrices are U.S. Pat. Nos. 3,957,741 and 4,035,316.

“Super-paramagnetic” especially means that the permeability μᵣ is between that of paramagnetic materials and that of ferromagnetic materials (in other words: μ_{r(paramagnet. material)}<μ_{r (superparamagnettc material)}<μ_{r ferromagnetic material)}), for example in the area of μᵣ approximately equal to 2 to μᵣ approximately equal to 100. All materials that fulfill the conditions mentioned hereinbefore are appropriate for the purposes of the present invention. The superparamagnetic properties are preferably achieved by embedding metal oxides, especially iron oxide (Fe₃O₄), or other appropriate metals or alloys. The metal particles are preferably fine and of relatively comparable size, so that the resulting particle diameter preferably has the sizes mentioned below. The metals are especially iron, nickel or cobalt, or alloys which, for example, further may comprise gadolinium, dysprosium or erbium, further vanadium, or other transition metals. Iron oxide (especially magnetite) is preferred. Some ferrites, such as lithium ferrite, are also possible.

Preferred beads have a mean diameter of 2 μm or less, especially of 1 μm or less (for example in order not to be stuck in the capillary system), in particular of 30 to 1000 nm, more especially from 30 to 300 nm. Especially preferred are beads with a biologically degradable matrix, e.g. from carbon hydrates (especially polysaccharides) or poly-amino acids. All these beads, as well as analogues thereof, are appropriate within the bounds of the present invention. The beads may also, in addition, be labelled with gamma-emitters (such as Technetium-99 m) in low activity in order to trail the movement of particles (optionally loaded with active substances), for example inside the body, by means of a gamma-camera.

Especially the firm Miltenyi Biotec Gmbh, Bergisch Gladbach, Germany, for example, offers, under the designation “MicroBeads”, free or antibody-labelled beads with an average size of approximately 50 nm which contain iron oxide inside a polysaccharide matrix—these have the big advantage to be also biodegradable, and, therefore and due to their small size, are very preferred. From the firm Polysciences, Inc., under the designation “BioMag®” Beads of ca. 1 μm size are offered which consist of an iron oxide nucleus with a silane coating and are functionalized with amino or carboxyl groups which allow the covalent binding to proteins (such as antibodies, avidin, streptavidin), glycoproteins, polysaccharides, lectines and other ligands. Sigma-Aldrich also offers super-paramagnetic beads of approximately 1 μm diameter which are on iron oxide basis, and, on the surface, as functional groups carry either carboxyl- or amino groups. Further superparamagnetic beads are offered by the German “Deutschen Dynal GmbH”, Hamburg, Germany, and by a number of other firms.

Examples for active substances that can be used according to the invention are especially antitumor-active chemotherapeutics which (alone or as combination of two or more of the mentioned substances) may, as embodiment of the invention, find use as active substance, especially those mentioned in the following list:

(A) Alkylating agents, such as dacarbazine (DTIC-Dome); mustard gas derivatives, such as mechlorethamine (mustargen); ethyleneimine derivatives, e.g. triethylenethiophosphoramide (thio-tepa); procarbazine (Matulane); alkylsulfonates such as busulfan (Myeleran); cyclophosphamide; 4-hydroxyperoxycyclophosphamide (4-HC); mafosfamide; ifosfamide; melphalan (Alkeran); chlorambucil (Leukeran); nitroso ureas such as cyclohexylnitroso urea (meCCNU; Carmustin, BCNU, BiCNU) or lomustin (CCNU, CeeNU), cis-platin(II)-diamindichloride (Platinol or Cisplatin); carboplatin (Paraplatin); preferably other cross-linking chemotherapeutics, especially bis-alkylating agents, preferably mustard gas derivatives such as alkylsulfonates such as busulfan; or compounds that effect cross-links via ionic bonds, like ethylenimine-derivates, e.g. triethylenthiophosporamide (Thio-tepa);

(B) antitumor antibiotics, preferably selected from the group consisting of bleomycine (Blenoxane); anthracyclines, such as daunomycin, dactinomycin (Cosmegen), daunorubicin (Cerubidin), doxorubicin (Adriamycin, Rubex), epirubicin, esorubicin, idarubicin (Idamycin), plicamycin (Mithracin, formerly designated as Mithramycin) and especially cross-linking (bis-alkylating) antitumorantibiotics, such as Mitomycin C (Mitomycin, Mutamycin);

(C) antimetabolites, e.g. folic acid analogues such as Methotrexate (Folex, Mexate) or Trimetrexate; purin nucleoside analogues such as cladribine (Leustatin; 2-chloro-2′-deoxy-β-D-adenosine), 6-mercaptopurine (Mercaptopurin, Purinethol, 6-MP), pentostatin (Nipent) or 6-thioguanine (6-TG, Tabloid); pyrimidine analogues such as 5-fluoruracil (Fluoruracil, 5-FU), 5-fluordeoxyuridine (Floxuridine, FUDR), cytosinarabinoside (Ara-C, cytarabine, Cytosar-U or Tarabin PFS), fludarabinphosphate (Fludara) or 5-azacytidine; hydroxy urea (Hydrea); or polyaminebiosynthesis inhibitors, espeially ornithindecarboxylase- or S-adenosylmethionindecarboxylase inhibitors, e.g. those mentioned in EP 0 456 133, especially 4-amidino-1-indanon-2′-amidinohydrazone;

(D) plant alkaloids, especially vinca alkaloids, such as vinblastine (Velban), vincristine (Oncovin) or vindesine; epipodophyllotoxines, such as etoposide (VP-16, VePesid) or teniposide (VM-26, Vumon);

(E) hormonally active agents and antagonists, especially adrenocorticoids, such as prednisone (Deltason) or dexamethasone (Decadron); progestines such as hydroxyprogesterone (Prodox), megestrolacetate (Megace) or medroxyprogesterone (Provera, Depo-Provera); androgens such as testosterone or fluoxymesterone (Halotestin); estrogens such as diethylstilbestrol (DES), estradiol or chlorotriansiene (Tace); synthetic analogs of LHRH, such as goserelin (Zoladex); synthetic analogs of LH-releasing hormone, such as leuprolide (Lupron, Lupron Depot); anti-androgens such as flutamide (Eulexin); anti-estrogens such as tamoxifen; aromatase inhibitors such as aminogluthetimide (Cytadren), lentaron (Formestane, 4-hydroxy-4-androsten-3,17-dione) (see EP 0 162 510), fadrozole (5-(p-cyanophenyl)-5,6,7,8-tetrahydroimidazo-[1,5-a]pyridine, see EP 0 437 415 and EP 0 165 904), letrozole (4,4′-(1H-1,2,4-triazol-1-yl-methylen)-bis-benzonitrile, see U.S. Pat. No. 4,976,672), arimidex, 4-(α-(4-cyanophenyl)-α-fluoro-1-(1,2,4-triazolyl)methyl)-benzonitrile (see EP 0 490 816) or 4-(α-(4-cyanophenyl)-(2-tetrazolyl)methyl)-benzonitrile (see EP 0 408 509); adrenally cyctoxic agents, such as mitotane (Lysodren); somatostatin analogues, such as octreotide (Sandostatin); or 5α-reductase inhibitors, such as N-(1-cyano-1-methyl-ethyl)-4-aza-3-oxo-5α-androst-1-en-17β-carboxamide (see EP 0 538 192);

(F) modifiers of biological processes (biological response agents), especially lymphokines, such as Aldesleukin (human recombinant IL-2, Proleukin); or interferones, such as Interferon-α (Intron-A, Roferon) or Interferon “B₁B₂B₃D₄” (see EP 0 205 404);

(G) Inhibitors of protein tyrosin kinases and/or serine/threonine kinases, such as N-{5-[4-methyl-piperazino-methyl)-benzoylamido]-2-methyl-phenyl}-4-(3-pyridyl)-2-pyrimidine (see EP 0 546 409), N-(3-chlorphenyl)-4-(2-(3-hydroxy)-propyl-amino-4-pyridyl)-2-pyrimidinamine (see EP 0 606 046), N-benzoyl-staurosporine (see EP 0 296 110), 4,5-bis(anilino)-phthalimide (see EP 0 516 588), N-(5-N-benzoylamido-2-methyl-phenyl)-4-(3-pyridyl)-2-pyridinamine (seh EP 0 564 409) or 4-(m-chloroanilino)-5,6-dimethyl-7H-pyrrolo[2,3-d]pyrimidine (see EP 0 682 027);

(H) antisense oligonucleotides or oligonucleotide derivatives, for example aiming against raf (see WO 95/32987) or PKC, against SAMDC (PCT application WO 96/05298); or

(I) mixed-functional agents or agents with other or unknown mechanisms of action, for example S-triazine derivatives, e.G. altrematin (Hexalen); enzymes, such as asparaginase (Elspar); methylhydrazine derivatives, such as dacarbazine und procarbazine; matrixmetalloproteinase inhibitors, hexamethylmelamine, pentamethylmelamine; anthraquinones such as mitoxantrone (Novantrone); mitotic spindle poisons such as paclitaxel (Taxol), epothilone A, epothilone B, epothilone derivatives or discodermolide; streptozocine (Zanosar); estracyte (Estramustin); Amsacrine; agents with cell differentiation promoting effect, such as all-transretinic acid (TRA); immunomodulators, such as levamisole (Ergamisol); vaccines, such as anti-melanome vaccines (see EP 0 674 097) ; or antibodies that are effective against tumors, for example antibodies directed against melanome antigens (see EP 0 640 131), antibodies for the active immunotherapy of melanomas (see EP 0 428 485), antibodies against colon cancer (Panorex®), antibodies against Non-Hodkin-Lymphoma (Rituximab), antibodies against breast cancer (Trastuzumab), antiidiotypy antibodies such as TriaAb® or CeaVac® (Titan Pharmaceuticals, Inc.) and (for example recombinant) proteins conjugated with the part of the TAT protein of AIDS virus that consists of eleven aminop acids and which allows for the penetration of cell membranes, such as proteins having influence on the cell regulation or correspondingly modified antibodies which, inside a cancer cell, can bind and thus inactivate degenerated proteins, such as degenerated tyrosine- or serine/threonine kinases.

As compounds effective against infections especially antibiotics, antivirally active substances, such as inhibitors of the reverse transcriptase or retroviral proteases, such as the HIV protease, or active compounds effective against viral hepatitis (such as HCV), for example interferone (especially interferon-alfa-2) and/or ribavirin, or antibodies can find use.

The compounds mentioned can also be present as salts, especially as pharmaceutically acceptable salts, if they have appropriate salt-forming groups. Salts of active substances with basic groups can, for example, be acid addition salts, such as halogenides, methansulfonates or sulfates, active substances with acidic groups can form salts with bases, such as metals, or ammonium salts of ammonia or substituted amines. The active substances can either be coupled (conjugated) covalently directly (preferably via spacers) to the superparamagnetic beads, or worked in into liposomes which are or can be labelled with super-paramagnetic beads which are bound non-covalently (e.g. via antigens conjugated to lipids that are presented at the liposome surface and allow for the linking up of antibodies labelled with superparamagnetic beads, or by making use of the biotin/avidin or biotin/streptavidin interaction) or by direct covalent bonding or covalent bonding via spacers to the liposomes (bound e.g. to components of the liposome envelope, such as amino groups of lecithins, or amino, hydroxy or carboxy groups at acyl moieties that belong to the liposome-forming phospholipids, or the like). Alternatively, superparamagnetic materials, for example directly corresponding iron oxide particles, can be present directly integrated into the liposomes. Also super-paramagnetic beads merely labelled by antibodies (which may, at the same time, also work as therapeutic active substances) can be used as they also recognize the corresponding diseased cells and make them amenable to the treatment with DM fields.

Examples of liposome formulations are known; thus a liposome dispersion (phospholipid-stabilized dispersion) capable of being used in the present invention comprises

a) a phospholipid or several phospholipids of the formula A,

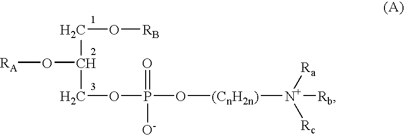

wherein R_{A} is C₁₀₋₂₀-acyl, R_{B} is hydrogen or C₁₀₋₂₀-acyl, Rₐ, R_{b} and R_{c} are hydrogen or C₁₋₄-alkyl and n is an integer from two to four, optionally

b) an additional phospholipid or several additional phospholipids;

c) one or more active substances and

d) a pharmaceutically acceptable carrier liquid and optionally further adjuvants and/or preservatives.

The process of manufacture for these dispersions is characterized in that a solution of suspension of components a) and c) or a), b) and c), preferably of a) and b) in a proportion by weight from 20:1 to 1:5, especially from 5:1 to 1:1, is converted into a dispersion by dilution with water, the organic solvent is subsequently removed, for example by centrifugation, gel filtration, ultrafiltration or especially dialysis, e.g. tangential dialysis, preferably against water, and the dispersion thus obtained, preferably after addition of adjuvants or preservatives, if required, concentrated if it does not already have the correct concentration of the active substance, under adjustment of an acceptable ph-value by addition of pharmaceutically acceptable buffers, such as phosphate salts or organic acids (pure or dissolved in water), such as acetic acid or citric acid, preferably between pH 3 and 6, for example pH 4-5, preferably to a concentration of the active substance from 0.2 to 30 mg/ml, especially from 1 to 20 mg/ml, where the concentrating preferably is achieved according to the methods last mentioned for the removal of an organic solvent, especially by ultrafiltration, for example using an apparatus for the undertaking of tangential dialysis and ultrafiltration.

The dispersion, stabilized by phospholipids, obtainable according to this process is stable for at least several hours at room temperature, reproducible with regard to the proportion of the components and toxicologically harmless and is thus especially appropriate for the oral or intravenous administration to warm-blooded animals, especially humans.

The range of size of the obtained particles in the dispersion is variable and preferably is between approximately 1.0×10⁻⁸ to approximately 1.0×10⁻⁵ m, especially between about 10⁻⁷ and about 2×10⁻⁶ m.

The nomenclature of the phospholipids of the formula A and the numbering of the C-atoms takes place according to the recommendations given in Eur. J. of Biochem. 79, 11-21 (1977) “Nomenclature of Lipids” of the IUPAC-IUB Commission on Biochemical Nomenclature (CBN) (sn-nomenclature, stereo-specific numbering).

In a phospholipid of the formula A R_{A} and R_{B} with the meanings C₁₀₋₂₀-acyl are preferably straight-chain C₁₀₋₂₀-alkanoyl with an even number of carbon atoms (unsubstituted or substituted, especially by functional groups that allow a docking to antibodies, beads or the like, for example hydroxy, amino or carboxyl) and straight-chain C₁₀₋₂₀-alkenoyl with a double bond and a straight number of C-atoms (unsubstituted or substituted, especially by functional groups that allow a coupling to antibodies, beads of the like, for example hydroxy, amino or carboxyl, whereby amino or hydroxy for reasons of stability should not be bound to C-atoms from which a double bond starts).

Straight-chain C₁₀₋₂₀-alkanoyl R_{A} and R_{B} with an even number of C-atoms are, for example, n-dodecanoyl, n-tetradecanoyl, n-hexadecanoyl or n-octadecanoyl. Straight-chain C₁₀₋₂₀-alkenoyl R_{A} and R_{B} with a double bond and an even number of C-atoms are, for example, 6-cis-, 6-trans-, 9-cis- or 9-trans-dodecenoyl, -tetradecenoyl, -hexadecenoyl, -octadecenoyl or -icosenoyl, especially 9-cis-octadecenoyl (oleoyl).

In a phospholipid of the formula A n is an integer from 2 to 4, preferably two. The group of the formula —(CₙH₂ₙ)— represents un-branched or branched alkylen, e.g. 1,1-ethylene, 1,1-, 1,2- or 1,3-propylene or 1,2-, 1,3- or 1,4-butylene. Preferred is 1,2-ethylene (n=2).

Phospholipids of the formula A are, for example, naturally occuring kephalins wherein Rₐ, R_{b} and R_{c} are hydrogen, or naturally occuring lecithins wherein Rₐ, R_{b} and R_{c} are methyl, e.g. kephalin or lecithin from soya beans, bovine brain, bovine liver, or hen's egg with different or identical acyl groups R_{A} and R_{B}, or mixtures thereof. The expression “naturally occurring phospholipids of the formula A” defines phospholipids, which, as regards R_{A} and R_{B}, have no uniform composition. That kind of natural phospholipids are also lecithins and kephalins, the acyl groups R_{A} and R_{B} of which are structurally indefinable and are deduced from naturally occurring fatty acid mixtures.

Preferred are synthetic, essentially pure phospholipids of the formula A with different or identical acyl groups R_{A} and R_{B}. The terminus “synthetic” phospholipid of the formula A defines phospholipids which, as far as R_{A} and R_{B} are concerned, have a uniform composition. That kind of synthetic phospholipids are preferably the lecithins and kephalins defined below, the acyl groups R_{A} and R_{B} of which have a defined structure and are derived from a defined fatty acid with a degree of purity of higher than about 95%. R_{A} and R_{B} can be identical or different and unsaturated or saturated. Preferably R_{A} is saturated, e.g. n-hexadecanoyl, and R_{B} is unsaturated, e.g. 9-cis-octadecenoyl (=oleoyl).

The terminus “essentially pure” phospholipid defines a degree of purity of more than 70% (by weight) of the phospholipid of the formula A which is detectable with the help of appropriate methods of determination, e.g. paper-chromatographically.

Especially preferred are synthetic, essentially pure phospholipids of the formula A, wherein R_{A} has the meaning of straight-chain C₁₀₋₂₀-alkanoyl with an even number of C-atoms and R_{B} has the meaning of straight-chain C₁₀₋₂₀-alkenoyl with a double bond and an even number of C-atoms, Rₐ, R_{b} and R_{c} are methyl and n=2.

In an especially preferred phospholipid of the formula A, R_{A} means n-do decanoyl, n-tetradecanoyl, n-hexadecanoyl or n-octadecanoyl and R_{B} means 9-cis-dodecenoyl, 9-cis-tetra-decenoyl, 9-cis-hexadecenoyl, 9-cis-octadecenoyl or 9-cis-icosenoyl. Rₐ, R_{b} and R_{c} are methyl and n is 2. A very especially preferred phospholipid of the formula A is synthetical 1-n-hexadecanoyl-2-(9-cis-octadecenoyl)-3-sn-phosphatidylcholine with a purity of more than 95%. Preferred natural, essentially pure phospholipids of the formula A are especially lecithin (L-α-phosphatidylcholine) from soya beans or hen's egg.

For the acyl moieties in the phospholipids of the formula A, also the designations given in parenthesie are common: 9-cis-dodecenoyl (lauroleoyl), 9-cis-tetradecenoyl (myristoleoyl), 9-cis-hexadecenoyl (palmitoleoyl), 6-cis-octadecenoyl (petroseloyl), 6-trans-octadecenoyl (petroselaidoyl), 9-cis-octadecenoyl (oleoyl), 9-trans-octadecenoyl (elaidoyl), 11-cis-octadecenoyl (vaccenoyl), 9-cis-icosenoyl (gadoleoyl), n-dodecanoyl (lauroyl), n-tetradecanoyl (myristoyl), n-hexadecanoyl (palmitoyl), n-octadecanoyl (stearoyl), n-icosanoyl (arachidoyl). Further phospholipids are preferably esters of phosphatidic acid (3-sn-phosphatidic acid) with the mentioned acyl moieties, such as phosphatidylserine and phosphatidylethanolamine.

In the carrier liquid d), the components a), b) and c) or a) and c) are included such as liposomes that for several days to weeks no solid matter or solid aggregates such as micelles are formed again and the liquid with the mentioned components is administrable, preferably orally or intravenously, if applicable, after filtration.

Within the carrier liquid d), pharmaceutically acceptable, nontoxic adjuvants may be included, for example water-soluble adjuvants that are appropriate for establishing isotonic conditions, e.g. ionic additives such as sodium chloride, or non-ionic additives (skeleton forming substances) such as sorbitol, mannitol or glucose, or water-soluble stabilisators of the liposome dispersion such as lactose, fructose or saccharose. In addition to the water-soluble adjuvants, in the carrier liquid emulgators, humectant or tensides appropriate for liquid harmaceutical cormulations may be present, especially emulgators such as oleic acid, non-ionic tensides of the fatty acid-polyhydroxyalcohol ester type, such as sorbitane monolaurate, -oleate, -stearate or -palmitate, sorbitane tristearate or -trioleate, polyoxyethylene adducts of fatty acid-polyhydroxyalcohol esters such as polyoxyethylen-sorbitane monolaurate, -oleate, -stearate, -palmitate, -tristearate or -trioleate, polyethylenglycol fatty acid esters such as polyoxyethylstearate, polyethylenglycol-400-stearate, polyethylenglycol-2000-stearate, especially ethylenoxide-propylenoxide blockpolymers of the Pluronic® (Wyandotte Chem. Corp.) or Synperonic® (ICI) type.

The liposomes can be separated from the free active substance, for example, by gel filtration, so that in the remaining dispersion no or only a very low amount of the active substance remains outside the liposomes.

Super-paramagnetic beads may either be bound covalently subsequently (for example by addition of bi-functional cross-linkers), or, for example in the mixture of the components (a) to (d) antigenic components may be present that integrate into the membrane (e.g. recombinant membrane proteins, such as CD4 or CD8, or low molecular haptenes, such as dinitrophenol, for example in place of the moieties Rₐ, R_{b} or R_{c}), to which then superparamagnetic beads conjugated to the corresponding antibodies can be bound, or the super-paramagnetically labelled liposomes are produced by binding of biotin via a spacer, for example in place of one of the moieties Rₐ, R_{b} and/or R_{c}, and binding of avidin- or streptavidin-conjugated super-paramagnetic beads; or the liposomes themselves are loaded with paramagnetic materials, such as very small iron oxide particles that are added directly during the manufacture of the liposomes in addition to the active substance, the liposomes thus themselves forming a type of super-paramagnetical beads. Preferred preservatives are e.g. antioxidants, such as ascorbic acid, or microbizides, such as sorbic acid or benzoic acid.

Especially preferred are superparamagnetic beads conjugated to antibodies (especially directed against infected cells, such as HIV infected lymphocytes or virus (e.g. HCV)-infected liver cells, or against tumor cells), or active-substance-including liposomes coupled with superparamagnetic beads and corresponding antibodies each of which are enriched after injection at the location of the tumor and which are brought into movement directly be means of the DM fields and thus, by mechanical stress or, in the case of liposomes, in addition by release of the active substance under the influence of the DM field, make possible antitumor action directly at the site of the infected cells or the tumor site. Analogously, the use of antibodies directed against parasites is possible.

The ways of administration comprise, inter alia, the enteral, wuch as nasal, oral or rectal one; or the parenteral, such as intradermal, subcuntaneous, intramusclular, and especially the intravascular (especially intravenous), intralumbar, intracranial or intracavital (e.g. into the abdominal cavity or other body cavities, into muscle fascia or the like) injection or intravascular infusion

The enteral (for example oral) administration is especially appropriate for the treatment of diseases that are accessible form the lumen of the intestinum, lung, pharynx, mouth and/or nose. Within the respective rooms the superparamagnetic beads, for example coupled to active substances or liposomes carrying active substances may, if desired, be manoeuvred to the desired locations inside the body.

The parenteral administration is especially appropriate for the treatment of diseases that are accessible via the blood circulation (especially infusion, intravascular injection), are protected against the arrival of the active substance behind the blood-brain barrier, or are accessible from body cavities (e.g. abdominal cavity, interpleural cavity, interfascicular space or the like), whereby in the case of body cavities again the possibility exists to manoeuvre, by means of DM fields, the superparamagnetically labelled substance or the correspondingly labelled liposomes to the desired locations. The administration may take place locally (at the site of the disease to be treated, e.g. by injection) or systemically (e.g. by intravascular injection or infusion).

The dosage amounts to be administered to warm-blooded animals, e.g. humans of about 70 kg of body weight, expressed as the amount of the active substance, vary depending on the species, age, individual condition, mode of administration and the respective clinical characteristics and, for non-polymer active substances (other than e.g. proteins or antibodies) lie especially between about 0.1 mg and about 10 g, preferably between about 0.4 and about 4 g, e.g. at approximately 1 mg to 1.5 g per person and day, divided into preferably 1 to 3 single doses that may be of equal size. In the case of polymeric active substances, the dosage, expressed, as amount of the active substance, especially lies between 0.05 und 50 mg, preferably between 0.1 und 10 mg per person and day. Normally, children receive half the dosage of adults. Where required, the treatment may be continued as long as is required for tumor treatment and/or for the prevention of the formation of metastases.

For the coupling of active substances or liposomes (with or without antibody labelling, loaded with active substance) (subsequently both designated reaction partner A) to super-paramagnetic beads (subsequently designated reaction partner B), or of (especially infection, parasite or tumor specific) antibodies (reaction partner A) to liposomes or superparamagnetic beads (reaction partner B, each), that are loaded with active substances, customary processes are used, e.g. the cyanogenbromide activation for example of the beads surface if OH groups are present, or the milder treatment with heterobifunctional coupling reagents that first can react with the molecule to be coupled or functional groups present at the surface of the beads or the liposome, especially hydroxy, amino, carboxyl, epoxide, thiol or diene groups or reactive forms thereof, and then subsequently or in the same charge at essentially the same time with groups on the molecules or antibodies to be bound. Non-covalent binding is possible by coupling avidin or streptavidin to reaction partner A, to reaction partner B to be bound biotin, or vice versa.

The covalent coupling can, for example, take place at epoxy groups or carboxyl groups functionalized as activated esters (reactive form). The reactive carboxyl groups can also be synthesized in situ (for example making use of reagents customary in peptide chemistry, e.g. for the preparation of 1-hydroxybenzotriazole, succinimide- or N-hydroxysuccinimide esters, or in situ derivatisation e.g. with carbodiimides, such as dicyclohexylcarbodiimide, with carbonylimidazole, with N-[(dimethylamino)-1H-1,2,3-triazolo[4,5-b]pyridin-1-ylmethylene]-N-methylmethanaminiumhexafluorophosphate-N-oxide (HATU); with 2-(1H-benzotriazol-1-yl)-1,1,3,3-tetramethyluroniumtetrafluoroborat (HBTU), with 2-(pyridon-1-yl)-1,1,3,3-tetramethyluroniumtetrafluoroborate (TPTU); or benzotriazol-1-yl-oxy-tris(dimethylamino)-phosphoniumhexafluorophosphate (BOP), or similar reagents). The reaction then takes place mainly with amino, but also hydroxy or mercapto groups at the complementary partner to be coupled. Further, (i) azide or (ii) diene-modified reaction partners A or B may be reacted with the corresponding complementary reaction partner, which in case (i) contain diene groups, in case (ii) contain azide groups, which together are appropriate for a Diels-Alder coupling.

As heterobifunctional reagents, for example those can be used that comprise a group that reacts with amino, hydroxy or mercapto groups, and contain a further group which is a disulfide and can, subsequently, be reacted under liberation of mercapto groups (e.g. with dithiothreitol or similar reductants). Other possible heterobifunctional reagents carry, e.g., an amino-reactive group and a photo-activatable group, for example N-hydroxysuccinimidoyl-4-azido-salicylic acid. Still other heterobifunctional reagents comprise, e.g., an amino and a mercapto-reactive group, or two different amino-reactive groups, for example succinimidoyl-maleinimide derivates, such as succinimidoyl-butylphenyl-maleinimide, N-ε-maleimidocaprylic acid or N-(ε-maleimido caprylic acid), or the like. An example for a hydroxy- and sulfhydryl-reactive heterobifunctional reagent is N-(ρ-maleimidophenyl)isocyanate.

As mentioned, superparamagnetic beads or other reaction partners B can be activated by cyanogenbromide, but also by epoxy, nitrophenylchloroformate, N-hydroxysuccinimide or chloroformate groups, by polyacrylazido moieties (photo-activatable), epoxide groups, bromoacetyl groups, epichlorohydrine activation, tresyl-chloride activation, vinylsulfone activation, or the like.

Novel combination products (e.g. of antibodies with superparamagnetic beads, or of active substances with liposomes and/or active substances), are also an embodiment of the present invention.

The invention especially relates to the embodiments of the invention as mentioned in the examples.

### FIGURES

FIG. 1: The Lorentz force is called by Antoon Lorentz himself an electric force and is indeed formally identical to the electrical distant effect (Coulomb force). The Lorentz force works on electric charges in a magnetic field. In the demonstration experiment of FIG. 1, the effect of the Lorentz force on ions is demonstrated. To this effect, a dynamic homogenous magnetic field is produced (see WO 95/19217) which penetrates a mixture of salt water and sand filled into a transparent plastic box which is hermetically sealed from the external. The field is passed back with negligible losses through a laminated iron core (also metal sheets returning the field), laminated cores are not necessary in the case of very low frequencies (e.g. 15 Hz or lower) of the dynamic fields. (4) is a symbolic closed field line. (5) shows, as an example, a slot section with a part of the winding of the DM field producer (6). Further details see example 3. An electric force—the Lorentz force—is able to transport positive and negative ions which can be magnetic or not magnetic in the same direction. This is not possible with the Coulomb force.

FIG. 2: This figure shows this time only the magnetic aspects. Above a DM field generator (6), a transparent plastic vessel (8) is situated which is filled with water. A magnetite bead (7) can be reversibly moved longitudinally through the liquid in the sense of and counter to the arrow. This is not possible with an aluminium piece instead of a magnetite bead (7). (9) symbolizes a closed field line, (10) a slot section with a part of the winding. It is not possible to describe a multi particle problem in a mathematically exact way, the pure magnetical character of the effect of the action of the DM field can, however, be demonstrated.

FIG. 3: The figure shows a possible application of the invention: In a sample (5) placed under a microscope (12) in front of its objective (13) on the microscope table (14), e.g. cells, cell parts or pathogens and a relatively small amount (in the most extreme case only one) of cells, cell parts or pathogens labelled with superparamagnetic beads (bound via according antibodies). On both sides of the sample, the DM-field generator (11) can be recognized which is integrated into the microscope table. There can be two active DM-field generators, one DM-field generator and a magnetic return way or only one DM-field generator without return way. The magnetic field with a variable frequency, amplitude or direction passes through the sample. The observer now is able on his own to change e.g. the frequency, the amplitude or the direction of the dynamic field passing through the sample. This can be achieved by means of electronic circuits, equal to classical frequency converters that are controlled, or controlled and switched over, by regulation equipment, e.g. foot pedals, switches or the like. Hereby, the labelled objects can be manipulated accordingly. It is possible, for example, to produce reversibly (in a mathematical positive or negative sense) constant or inconstant rotary motions of the labelled object (angular moment conservation). Hereby, already only few or even single labelled objects can be recognized among even large numbers of unmarked others. It is, however, also possible, by observer-activation of the control circuits, to divide the dynamic magnetic field into multiple independent static magnetic AC fields which lead to a magnetic freezing in of the observed objects. All this allows for observing single labelled objects among a large number of unlabelled objects with high selectivity.

FIG. 4: This figure shows labelled objects (16) (e.g. cells) in disorder. These are brought into rotatory motion (17) (see description hereto under FIG. 3). A rotation in the opposite direction can also be established, or permanent changes in the rotatory motions. Under (18), a production of a structure of the labelled objects (rod-like) is shown (see description under FIG. 3). It is possible to achieve directed movements of the labelled objects by which other, even unlabelled objects can be labelled and transported.

The following examples serve for the illustration of the invention without that they shall limit the scope thereof.

### EXAMPLE 1

### Labelling of Lymphocytes

Production of lymphocytes from blood: 20 IE Heparin per ml of blood are introduced into a 20 ml injection syringe and venous blood is drawn up into it. To this heparin blood, about 4 ml Macrodex 6% (Knoll, Ludwigshafen, Germany) are added, and the syringe is placed in a rack at room temperature for about 1 hour. After that time, the nearly erythrocyte-free supernatant is taken up into a seconds syringe equipped with a canule. The blood is filled up 1:1 with phosphate buffered saline (PBS) (150 mM sodium chloride, 150 mM sodium phosphate, pH 7.2). For complete isolation of the lymphocytes, 3 ml of lymphocyte separation medium (Ficoll solution of 1,077 g/ml density) are put into a centrifuge tube and 4 ml of the blood/PBS solution layered carefully onto the separation medium (pipet carefully to avoid the mixture of the phases). After sealing with a silicone stopper, the gradient is centrifuged at 400 g (referring to the middle of the tube)) during 30 min at room temperature (during centrifugation it has to be taken care that the electric brake of the centrifuge remains switched off during the run); this results in the formation of 4 phases: top layer plasma, below it an opaque whitish band (peripheral monocytic blood cells), then the lymphocyte separation medium, and as pellet the remaining erythrozytes together with the granulocytes. The plasma is withdrawn by means of a pasteur pipette.

Optionally monocytes present may be removed by transfering the layer with the peripheral monocytic blood cells into a Petri dish. The B- and T-lymphocytes here remain in the supernatant, while other cell types adsorb themselves to the surface of the petri dish.

The cells in the supernatant or (if the monocytes are not removed further) the withdrawn plasma are then taken up into a buffer solution—PBS (as free of calcium and magnesium ions as possible in order to avoid the aggregation of the cells to each other of to surfaces) with 2 mM EDTA and 0.5% bovine serum albumine (BSA), subsequently called PBS*—and passed through a Nylon-mesh or a Nylon filter (Miltenyi Biotec GmbH, Bergisch Gladbach, Germany) in order to remove any clots. The cells are counted and washed in the last-mentioned buffer solution by means of centrifugation. The pellet with the cells is then incubated with MACS MultiSort Microbeads (Miltenyi Biotec GmbH, Bergisch Gladbach, Germany) that are labelled with CD4- (or CD-8-) antibodies (these are beads conjugated to anti-CD4-antibodies (or to anti-CD8-antibodies)with iron oxide in a polysaccharide matrix, diameter approximately 50 nm): The cells (10⁷ cells)are taken up in 80 μl PBS*. After addition of 20 μl MACS CD4 (or alternatively CD8) Microbeads-Suspension (Miltenyi Biotec GmbH, Bergisch Gladbach, Germany), incubation follows for 10 min at 4° C. After the incubation, the cells are taken up in the 10- to 20-fold amount of PBS*, centrifuged at 300×g for 10 min and, after complete removal of the supernatant, taken up in 500 μl buffer per 10⁸ labelled cells.

Subsequently, the magnetic accumulation is achieved by columns that are filled with beads from plastic coated ferromagnetic material in the presence of a magnetic field: A MS⁺-column (Miltenyi) is placed in the magnetic field of a permanent magnet (separator from Miltenyi). The column is prepared by washing with 500 μl PBS*; subsequently the cell suspension mentioned above is applied. The unlabelled cells are washed out with PBS* (3×500 μl ). The column is then removed from the separator, placed above an appropriate collection tube and eluted with 1 ml PBS*. The CD4 (or CD8)-cells with magnetically labelled cells are obtained.

### EXAMPLE 2

### Identifying of Magnetically Labelled Cells Under the Microscope

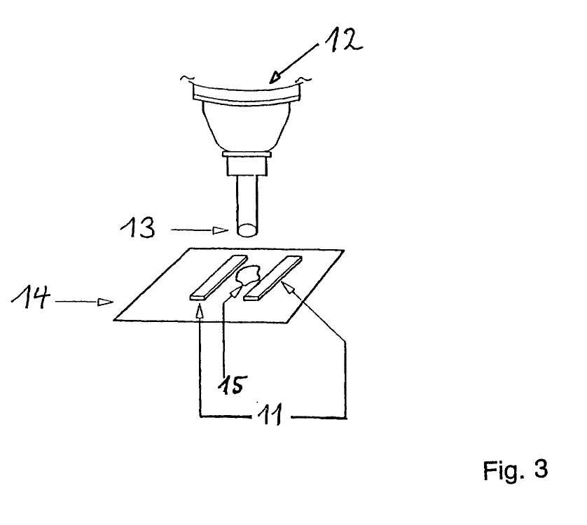

The magnetically labelled cells produced in example 1 are subsequently microscopically brought into motion by means of a DM field according to the invention (rotation or migration) (FIG. 3); as device for the generation of the magnetic field structure serves DM field generator (11), whereby 2 active field generators are used, or alternatively one active field generator and a magnetic short-circuit, or even only one DM field generator without magnetic short-circuit. It is possible to move the labelled cells in this way. This demonstrates that the principle of the invention is really applicable.

Within the sample placed under the microscope, a large number of unlabelled cells is present and a smaller (depending on the sample even very small) number of labelled cells, labelled with the corresponding antibody and magnetite particles conjugated to it. For example by causing constant/inconstant rotations of the labelled object in the mathematically positive or negative sense constant/inconstant rotations of the labelled cells can be achieved. Also few or even single labelled objects can thus be identified under a multitude of others. By the observer-activated electronic circuits the dynamic magnetic field is divided up into several independent static magnetic fields. By this method also a congealing of the labelled cells can be achieved. Also this allows to identify single labelled cells among unlabelled cells that remain mobile.

### EXAMPLE 3

### Transport Model for the Transportation of Salts within a Body

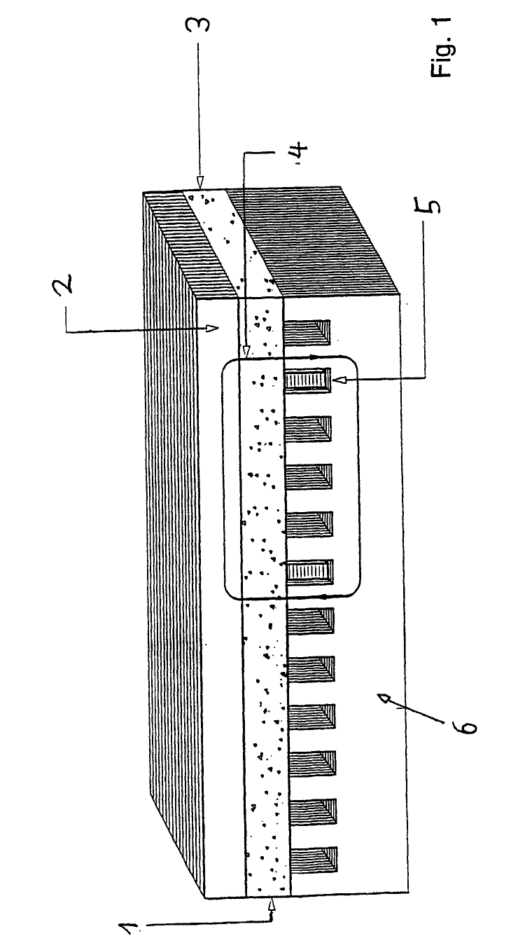

In a plastic vessel (1) filled with a mixture of salt, water and sand (FIG. 1, (3)) (as a model for a body) it is demonstrated that it is possible to move ions by wandering fields produced by means of the DM field generator (6). By introducing the Lorentz force a dynamic (local) homogeneous magnetic field according to WO 95/19217 is generated that can penetrate the plastic container and can be led back with only poor losses through a laminated core (field return way (2)), and it can be shown that at the end of the experiment more of the nonmagnetic sodium and chloride ions can be found on one side of the plastic container than on the other side. In other words, the experiment shows further that it is possible to produce concentration gradients of salts in order, for example, to investigate with proper experimental set up how such gradients affect cells (e.g. macrophages, protozoa) in corresponding experimental set-ups.

### EXAMPLE 4

### Model for a Transport of Magnetic Particles in a Body or a Solution, Especially for Sorting of Superparamagnetic Labelled Cells and of the Separation from Non-Labelled Cells

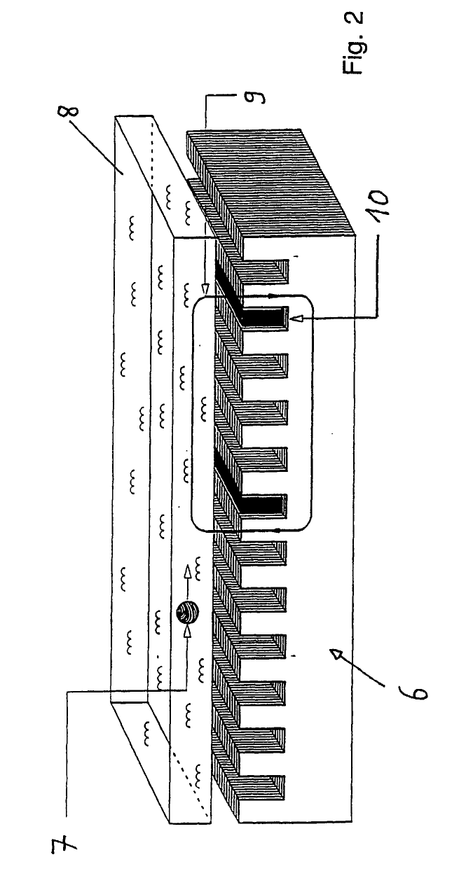

FIG. 2 shows a further arrangement to demonstrate the movement of a magnetic particle (here a paramagnetic sphere (7)—here as a magnetite sphere as a model). This is performed in a German university as a double blind experiment. Above a field producer (6) a transparent plastic vessel (8) is placed, filled with water. By moving fields, the bead is moved longitudinally for example in the arrow direction. With a nonmagnetic piece of aluminium, this motion cannot be performed under similar conditions.

### EXAMPLE 5

### Motion of Labelled Superparamagnetic Beads

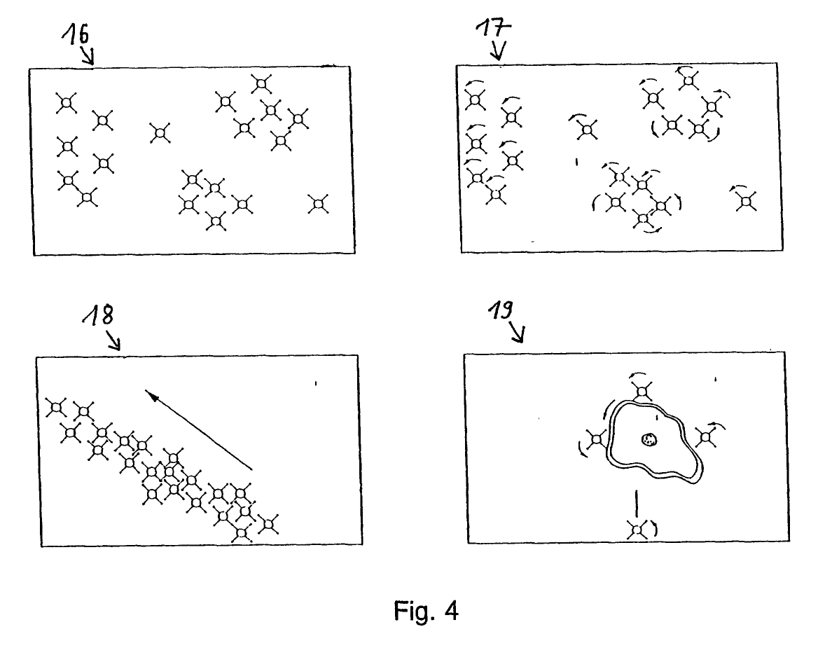

FIG. 4 shows superparamagnetic beads in disorder (Miltenyi). Through a (non-indicated) DM field generator, either the disordered beads (16) can be set in motion (19) (e.g. rotation (17) or directed motion (19)), or linearly extended compact structures can be built up by static AC fields (this would, inside the body, for example allow for the sealing of blood vessels by means of super-paramagnetic beads to thus stop the blood supply to a tumor or to infected tissue parts and thus kill them). Also target directed migration movements, alternating with rotation, of cells labelled with super-paramagnetic beads is possible (19). This demonstrates the applicability for example for the identification of specific cells (such as identification oft tumor cells by antibodies labelled correspondingly with super-paramagnetic beads) or especially for cell sorting (dragging out of the labelled cells from an admixture with unlabelled cells).

### EXAMPLE 6

### Movement of Rotatoria

A handful of hay is suspended with sand and water from a lake and left standing for a few days, whereupon Rotatoria develop. These are cultured in an Eppendorf-cup, and 10 μl of a suspension of 100-250 nm-Beads (magnetic polyalkylcyanoacrylate particles of the firm micromod Partikeltechnologie GmbH, Rostock, Germany) are added. The omnivores take up the beads. After a few hours, the animals are then brough to movement by a microscopic device, as shown in FIG. 3, by applying of DM fields.

1. Use of dynamic magnetic fields (DM fields), generated by alternating current-supplied multiphase systems, for the identification and/or sorting of cells, cell components or pathogens to which super-paramagnetic beads are bound.

2. The use according to claim 1, characterised in that the identification is used for the diagnosis of diseases of cells.

3. The use according to claim 2, characterised in that tumor cells or infected cells are identified to which super-paramagnetic beads are bound via antibodies specific for these cells.

4. Use according to one of claims 1 to 3, characterized in that it is applied extracorporally.

5. Use of a dynamic magnetic field, as defined in claim 1, in the purification of liquids from pathogens to which super-paramagnetical beads are bound.

6. Use according to claim 5, where the liquid to be purified is a unit of conserved blood or blood plasma, or a cell culture medium.

7. Process for the diagnosis, especially for the identification of diseased, especially infected cells, or tumor cells, which comprises the use of dynamic magnetic fields, as defined in claim 1, and super-paramagnetically labelled beads binding to said cells.

8. Process according to claim 7, characterized in that it is applied extracorporally.

9. Method of treatment of diseased cells, especially of infected cells or tumor cells, which comprises the use of dynamic magnetic fields, as defined in claim 1, and super-paramagnetic beads, which are present at the location of the infected cells or tumor cells or are bound to these.

10. Method according to claim 9, wherein the diseased cells are selectively labelled by super-paramagnetic beads, which are bound via antibodies to the diseased cells and, by applying a dynamic magnetic field as defined in claim 1, are exposed to stress by movement.

11. Method according to claim 9, wherein the diseased cells are labelled by super-paramagnetic beads which are directly coupled to an active substance, or to liposomes which carry an active substance of that type and, by applying a dynamic field as defined in claim 1, are transported to the site of action and/or are stimulated after labelling of the diseased cells in such a way that the cells are exposed more intensively to the active substance.

12. Method according to claim 9, characterised in that it is applied extra-corporally.

13. Use of super-paramagnetically labelled active substancees for the manufacture of a composition for use in a process for the treatment of infected cells or tumor cells, comprising the treatment with a dynamic magnetic field, as defined in claim 1, which (a) are administered at the site of the mentioned cells, (b) are manoeuvred there with a DM field or a DM field generator and/or (c) are being or have been bound to said cells, especially via antibodies bound to them specific for antigens on the cells to be treated.

14. Combination of super-paramagnetically labelled active substances or super-paramagnetically labelled beads with a generator of a dynamic magnetic field, appropriate for the treatment of infected cells or tumor cells.
